(19) United States
(12) Patent Application Publication
(10) Pub. No.: US 2008/0093390 A1
(43) Pub. Date: Apr. 24, 2008

(54) GLUE DISPENSER AND DISPENSING PROCESS USING THE SAME

(75) Inventor: TAI-CHERNG YU, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/611,472

(22) Filed: Dec. 15, 2006

(30) Foreign Application Priority Data
Oct. 18, 2006 (CN) 200610063162.5

(51) Int. Cl. B65D 88/54; G01F 11/00; B67D 3/00

(52) U.S. Cl. 222/330; 222/331; 222/485

(57) ABSTRACT

An exemplary dispenser for glue or another adhesive is provided. The dispenser includes a container, a first nozzle, and a second nozzle. The container is configured for supplying pressurized glue. The first nozzle fluidly communicates with the container and allows pressurized glue to flow out therethrough along a first direction. The second nozzle fluidly communicates with the container and allows pressurized glue to flow out therethrough along a second direction different from the first direction. Further, a dispensing process using such a dispenser in a process of assembling lens module also is provided.

### BACKGROUND

1. Technical Field

The present invention relates generally to dispensers for glue, adhesive, or the like and dispensing processes using such dispensers.

2. Description of Related Art

Nowadays, lens modules are widely employed in camera systems and mobile phones for image capturing. Generally, a lens module includes a lens barrel, at least a lens group, a spacer, and a filter (e.g., IR-cut filter). The lens group, the spacer and the filter are assembled into the lens barrel and arranged along an optical axis thereof, in an order from an object side to an image side of the lens module. The filter is bonded with the spacer via a bonding layer formed of a glue/adhesive. The bonding layer is usually formed on a bonded-side of the spacer via a dispensing process.

A typical dispenser employed in above-mentioned dispersing process usually includes a glue container, an actuator, and a single nozzle. The actuator is configured for applying a pressure on glue contained in the glue container. The nozzle is in fluid communication with the glue container and is configured for allowing pressurized glue to flow out therethrough.

Generally, in the dispensing process, the glue is necessarily dispensed/distributed at the bonded-side of the spacer in a manner to facilitate a joining together of the lens barrel and spacer, in order to prevent the filter (or the filter and the spacer together) from peeling or otherwise becoming dislodged from the lens module. That is, the nozzle being accurately positioned at a correct position is necessary in order to obtain a suitable distribution of glue and the like on the bonded-side of the spacer and thus achieve the desired bonding. However, in a practical dispensing process, that the single nozzle being positioned might occasionally depart from the correct position is nearly inevitable, and thereby a glue re-dispensing process would thereby be necessitated in order to achieve the desired distribution of the glue on the bonded-side of the spacer. Such a re-dispensing process would degrade the productivity for assembling the lens module to at least some degree and would unduly prolong production time.

Therefore, what is needed is to provide a dispenser for a glue and a dispensing process using the same, in order to achieve a satisfactory distribution of glue and thereby promote a high productivity.

### SUMMARY

A preferred embodiment provides a dispenser for glue/adhesive. The dispenser includes: a container, a first nozzle, and a second nozzle. The container is configured (i.e., structured and arranged) for supplying pressurized glue (i.e., a pressurized flow of glue). The first nozzle is in fluid communication with the container and allows pressurized glue to flow out therethrough along a first direction. The second nozzle is in fluid communication with the container and permits pressurized glue to flow out therethrough along a second direction different from the first direction.

Another preferred embodiment provides a dispensing process for glue/adhesive using the above-mentioned dispenser. The dispensing process includes the following steps of:

preparing a lens module including a lens barrel and an optical assembly received in the lens barrel, the lens module defining a first annular region and a second annular region each configured for receiving glue/adhesive, the first annular region being arranged within the optical assembly at an image side thereof and adjacent to the lens barrel, the second annular region being arranged on an inner wall of the lens barrel and adjacent to the optical assembly at the image side thereof;

positioning the dispenser adjacent to the lens module in order to allow the first nozzle and the second nozzle to be positioned adjacent to the first annular region and the second annular region, respectively; and

dispensing pressurized glue through the first nozzle and the second nozzle, a first amount of the pressurized glue flowing out through the first nozzle into the first annular region, a second amount of the pressurized glue flowing out through the second nozzle the second annular region.

Other advantages and novel features will become more apparent from the following detailed description of embodiments when taken in conjunction with the accompanying drawings.

### BRIEF DESCRIPTION OF THE DRAWINGS

Many aspects of the present dispenser and dispensing process can be better understood with reference to the following drawings. The components in the drawings are not necessarily drawn to scale, the emphasis instead being placed upon clearly illustrating the principles of the present dispenser and dispensing process. Moreover, in the drawings, like reference numerals designate corresponding parts throughout the several views.

FIG. 1 is a schematic, partially cross-sectional view of a dispenser, in accordance with a preferred embodiment;

FIG. 2 is a schematic, partially cross-sectional view of a dispenser, in accordance with another preferred embodiment;

FIG. 3 shows a stage of a dispensing process using the dispenser of FIG. 1; and

FIG. 4 shows a subsequent stage of the dispensing process of FIG. 3.

The exemplifications set out herein illustrate various preferred embodiments, in various forms, and such exemplifications are not to be construed as limiting the scope of the present dispenser and dispensing process in any manner.

### DETAILED DESCRIPTION

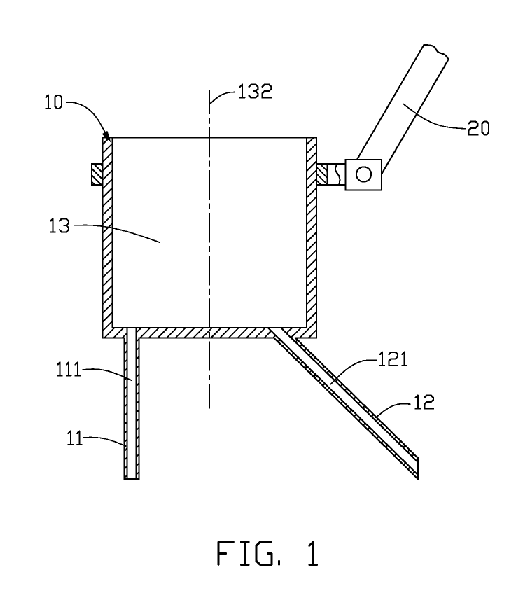

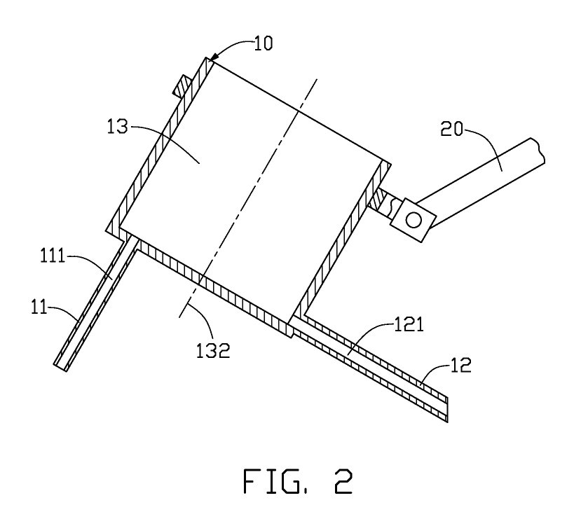

Referring to FIGS. 1 and 2, a dispenser 10, in accordance with a preferred embodiment is provided. The dispenser 10 includes a container 13, a first nozzle 11, and a second nozzle 12. The dispenser 10 usefully is held via an actuating arm 20, and thereby the dispenser 10 can be actuated to move along each of X, Y and Z axes, in a Cartesian XYZ rectangular coordinate system, and/or to rotate about an angle θ.

The container 13 is configured (i.e., structured and arranged) for supplying pressurized glue to the first nozzle 11 and the second nozzle 12. The container 13 can be, e.g., a hollow cylinder, in shape. The container can, advantageously, be sealed and placed under a controllable positive pressure, to thereby selectably promote a pressurized flow of glue/adhesive therefrom. Alternatively, a piston mechanism (not shown) could be used as mechanical pressure source to promote the desired flow of the glue. Finally, it could be possible to rely solely on gravity as the force/pressure to promote the flow of glue.

The first nozzle 11 extends from the container 13 along a first direction. The first nozzle 11 has a first channel 111 extending along the first direction and in fluid communication with the container 13. Such a configuration of the first nozzle 11 allows pressurized glue supplied by the container 13 to flow out through the first nozzle 11 along the first direction. Advantageously, the first nozzle 11 includes a flow control mechanism (e.g., a valve) to facilitate selectable flow therethrough.

The second nozzle 12 extends from the container 13 along a second direction. The second nozzle 12 has a channel 121 extending along the second direction and fluidly communicating with the container 13. Such a configuration of the second nozzle 11 allows pressurized glue supplied by the container 13 to flow out through the second nozzle 11 along the second direction. Advantageously, the second nozzle 12, like the first, includes a flow control mechanism (e.g., a valve) to facilitate selectable flow therethrough.

The second direction is different from the first direction, and suitably the second direction and the first direction intersect at an acute angle or a right angle relative to one another. As an illustrated embodiment, the first direction is parallel to a central axis 132 of the container 13, the second direction intersects with the central axis 132 at an acute angle (as shown in FIG. 1) or a right angle (as shown in FIG. 2). Alternatively, both the first direction and the second direction could intersect with the central axis 132 at a respective acute angle.

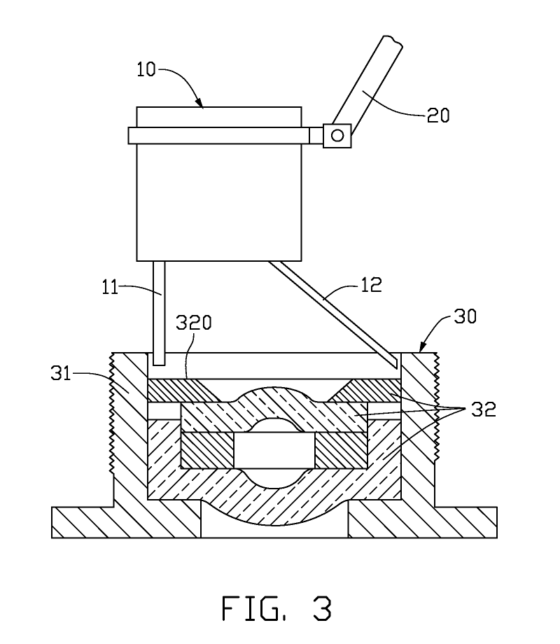

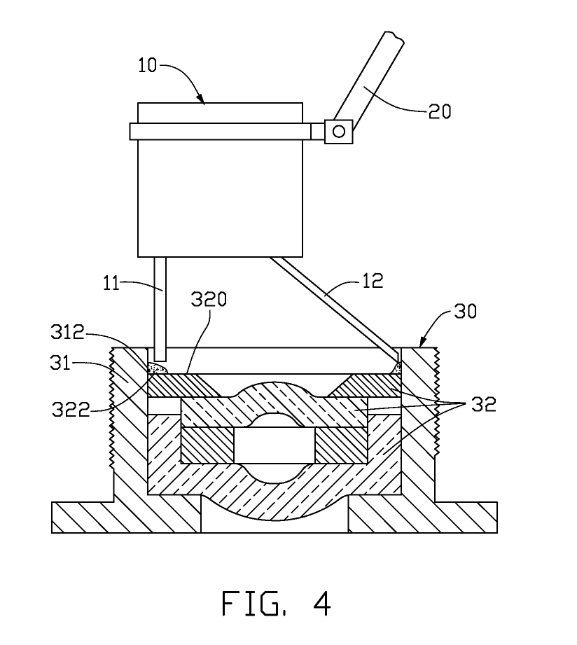

Referring to FIGS. 3 and 4, a dispensing process using the dispenser 10, in a process of assembling a lens module, will be described below in detail.

A pre-dispensing lens module 30 (i.e., a pre-dispensing target) is firstly provided. The lens module 30 includes a lens barrel 31 and an optical assembly 32 secured into the lens barrel 31. The optical assembly 32 has a pre-bonded side 320 configured for receiving the glue flowing out from the first nozzle 11 and the second nozzle 12, respectively.

The first nozzle 11 and the second nozzle 12 of the dispenser 10 are positioned adjacent to the optical assembly 32, via actuating the actuating arm 20. The first nozzle 11 and the second nozzle 12 thereby cooperatively allow pressurized glue to be dispensed in a manner to facilitate joining of the lens barrel 31 and the optical assembly 32. In particular, the first nozzle 11 is positioned to allow pressurized glue to be dispensed/distributed at a first annular region 322 on the pre-bonded side 320 of the optical assembly 32. The first annular region 322 extends along the circumferential direction of the lens barrel 31 and is located adjacent to the lens barrel 31. The second nozzle 12 is positioned to allow pressurized glue to be dispensed at a second annular region 312 on an inner wall of the lens barrel 31. The second annular region 312 extends along the circumferential direction of the lens barrel 31 and is located adjacent to the optical assembly 32, at an image side thereof.

A rotary movement of the lens module 31 relative to the dispenser 10 is carried out. Pressurized glue flows out through the first nozzle 11 and the second nozzle 12, respectively, along the first direction and the second direction. Such flow can occur continuously during such rotary movement or can occur at periodic intervals, depending on the gluing pattern desired.

As a result, the pressurized glue flowing out from the first nozzle 11 and the second nozzle 12 is, respectively, dispensed at the first annular region 322 and the second annular region 312, relative to the pre-bonded side 320 of the optical assembly 32. The glue dispensed at the first annular region 322 and the second annular region 312 will mix together, and thereby the dispensing process for glue is completely and thoroughly achieved in the process. Specifically, the resulting gluing concurrently provides sufficient attachment to both the lens barrel 31 and the optical assembly 32. Generally, after the completion of the dispensing process, an optical element, e.g., a filter including an IR (i.e., infrared) cut filter can be firmly bonded on the pre-bonded side 320 of the optical assembly 30 at the image side thereof, using the glue applied thereupon.

In sum, in at least one preferred embodiment, as above-mentioned, the dispenser 10 is configured to have more than one nozzle, e.g., the first nozzle 11 and the second nozzle 12, and the first nozzle 11 and the second nozzle 12 extends from the container 13 along different directions. Such a configuration of the dispenser 10 facilitates the achievement of a satisfactory distribution of glue/adhesive at the pre-bonded side of the pre-dispensing target, even if the first nozzle 11 and/or the second nozzle 12 should occasionally depart from a correct position to some extent in the dispensing process. That is, each amount of glue respectively deposited by the first nozzle 11 and the second nozzle 12 should contact at least some with both the lens barrel 31 and the optical assembly 32, even though contacting one more than the other. As such, a re-dispensing process for glue should prove unnecessary to carry out, and thereby a high productivity can be obtained. It is to be understood that the dispenser 10 could, potentially, be used to deposit fluids other than glue/adhesive, and such potential uses are considered within the scope of the present dispenser. Likewise, the dispenser 10 could be employed in processes other than the assembly of a lens module 30.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A glue dispenser, comprising:
a container configured for supplying pressurized glue;
a first nozzle fluidly communicating with the container and allowing a first amount of pressurized glue to flow out therethrough along a first direction; and
a second nozzle fluidly communicating with the container and allowing a second amount of pressurized glue to flow out therethrough along a second direction different from the first direction.

2. The dispenser of claim 1, wherein the first nozzle and the second nozzle extends from the container along the first direction and the second direction, respectively.

3. The dispenser of claim 2, wherein the first direction and the second direction intersect with each other at one of an acute angle and a right angle.

4. The dispenser of claim 3, wherein the container has a hollow cylindrical profile, and one of the first direction and the second direction is parallel to a central axis of the container, and the other one of the first direction and the second direction intersects with the central axis at one of an acute angle and a right angle.

5. The dispenser of claim 3, wherein the container has a hollow cylindrical profile, and at least one of the first direction and the second direction intersects with a central axis of the container at an acute angle.

6. A dispensing process using a glue dispenser, the dispenser including a container, a first nozzle, and a second nozzle; the first nozzle and the second nozzle fluidly each communicating with the container and allowing pressurized glue supplied by the container to flow out therethrough along a first direction and a second direction, respectively; the dispensing process, comprising:
preparing a lens module including a lens barrel and an optical assembly received in the lens barrel, the lens module defining a first annular region and a second annular region each for receiving glue, the first annular region being arranged within the optical assembly at an image side thereof and adjacent to the lens barrel, the second annular region being arranged on an inner wall of the lens barrel and adjacent to the optical assembly at the image side thereof;
positioning the dispenser adjacent to the lens module in order to allow the first nozzle and the second nozzle to be positioned adjacent to the first annular region and the second annular region, respectively; and
dispensing pressurized glue out through the first nozzle and the second nozzle, respectively, into the first annular region and the second annular region.

7. The dispensing process of claim 6, wherein at the step of dispensing, the pressurized glue flow out through the first nozzle and the second nozzle along the first direction and the second direction, respectively; and the first direction is different from the second direction.

8. A dispenser for depositing a fluid, comprising:
a container configured for supplying a pressurized fluid; and
at least two nozzles extending from the container, each nozzle fluidly communicating with the container and allowing pressurized fluid to flow out therethrough, the at least two nozzles being aligned along different directions relative to one another.

9. The dispenser of claim 8, wherein the different directions intersect with each other at one of an acute angle and a right angle.

10. The dispenser of claim 9, wherein the container has a hollow cylindrical profile, and at least one of the at least two different directions is parallel to a central axis of the container, and the other one of the at least two different directions intersects with the central axis at one of an acute angle and a right angle.

11. The dispenser of claim 8, wherein the container has a hollow cylindrical profile, and at least one of the different directions intersects with a central axis of the container at an acute angle.
